(19) United States
(12) Patent Application Publication
(10) Pub. No.: US 2025/0389311 A1
(43) Pub. Date: Dec. 25, 2025

(54) DIAPHRAGM AND SELF-LEVELIZER DAMPER INCLUDING THE SAME

(71) Applicant: HL MANDO CORPORATION, Pyeongtaek-si (KR)

(72) Inventors: Jongoh BAK, Pyeongtaek-si (KR); Kidon JUNG, Pyeongtaek-si (KR); Chunsung YU, Pyeongtaek-si (KR)

(73) Assignee: HL MANDO CORPORATION, Pyeongtaek-si (KR)

(21) Appl. No.: 19/247,736

(22) Filed: Jun. 24, 2025

(30) Foreign Application Priority Data
Jun. 25, 2024 (KR) 10-2024-0082546
May 21, 2025 (KR) 10-2025-0066151

(51) Int. Cl. F16F 9/346; F16F 9/10

(52) U.S. Cl. CPC F16F 9/346; F16F 9/10; F16F 2234/02

(57) ABSTRACT

A diaphragm is disclosed. The diaphragm is for a self-levelizer damper and includes an outer tube, a cylinder configured to surround the outer tube, and a first holder and a second holder spaced apart from each other between the outer tube and the cylinder, includes a diaphragm body which has a tube shape extending in a longitudinal direction and is disposed between the outer tube and the cylinder and of which both end portions in the longitudinal direction are coupled to the first holder and the second holder, and a plurality of ribs which extend in the longitudinal direction, protrude from an inner surface of the diaphragm body to be in contact with an outer surface of the outer tube, and form a plurality of flow paths extending in the longitudinal direction between the outer surface of the outer tube and the inner surface of the diaphragm body.

### CROSS-REFERENCE TO RELATED APPLICATION

This application claims priority to and the benefit of Korean Patent Application No. 10-2024-0082546, filed on Jun. 25, 2024, and Korean Patent Application No. 10-2025-0066151, filed on May 21, 2025, the disclosure of which is incorporated herein by reference in its entirety.

### BACKGROUND

### 1. Field of the Invention

The present disclosure relates to a diaphragm, and more particularly, to a diaphragm for a self-levelizer damper.

### 2. Discussion of Related Art

A damper of a vehicle is a shock absorber installed between an axle and a vehicle body to absorb vibrations and shocks received by the axle from a road surface when the vehicle is traveling, thereby improving ride comfort.

In general, larger amounts of cargo are frequently loaded in the trunks of wagons and sport utility vehicles (SUVs) than in those of sedans due to the natures of the vehicles.

In this case, the height of the vehicle is significantly lowered at the rear wheels due to the additional load, which increases a load input from a road surface and worsens ride comfort.

To solve such a problem, self-levelizer dampers are being applied to rear wheels to compensate for vehicle sagging due to an increase in loaded amount.

A self-levelizer damper is a device that, while a vehicle is traveling, basically increases the pressure in an internal chamber with a bump and rebound stroke force of a shock absorber to increase a height of the vehicle to a certain level to compensate a load from loading, thereby compensating for an amount of sagging.

A self-levelizer damper includes a relief valve. When the pressure in a high-pressure chamber increases excessively, the relief valve opens to allow oil of the high-pressure chamber to be discharged to a low-pressure chamber, thereby serving to manage the maximum pressure of the high-pressure chamber.

However, conventional self-levelizer dampers have a disadvantage in that oil does not smoothly move from a high-pressure chamber to a low-pressure chamber due to structural problems such as a decrease in a lateral flow path between a diaphragm and an upper holder and between the diaphragm and a lower holder, and due to diaphragm expansion during compression and extension of a damper even though a relief valve is provided, and thus the pressure of the high-pressure chamber increases excessively, which causes damage due to a decrease in durability of parts and causes severe noise.

### RELATED ART DOCUMENTS

### Patent Documents

(Patent Document 1) KR 10-2005-0107664A.

### SUMMARY OF THE INVENTION

The present disclosure is directed to providing a diaphragm capable of preventing the flow of oil between a high-pressure chamber and a low-pressure chamber from being blocked and improving an excessive increase in pressure of the high-pressure chamber.

The objects of the present disclosure are not limited to those described above, and other objects that are not described will be clearly understood by a person skilled in the art from the description below.

According to an aspect of the present disclosure, there is provided a diaphragm which is a diaphragm for a self-levelizer damper including an outer tube, a cylinder configured to surround the outer tube, and a first holder and a second holder spaced apart from each other between the outer tube and the cylinder, the diaphragm including a diaphragm body which has a tube shape extending in a longitudinal direction and is disposed between the outer tube and the cylinder and of which both end portions in the longitudinal direction are coupled to the first holder and the second holder, and a plurality of ribs which extend in the longitudinal direction, protrude from an inner surface of the diaphragm body to be in contact with an outer surface of the outer tube, and form a plurality of flow paths extending in the longitudinal direction between the outer surface of the outer tube and the inner surface of the diaphragm body, wherein the plurality of ribs and the plurality of flow paths are alternatively disposed in a circumferential direction of the diaphragm body, and connection flow paths are provided in the plurality of ribs to connect the flow paths adjacent to each other in the circumferential direction.

The diaphragm body may include a straight portion which is formed of a cylindrical tube having a constant diameter in the longitudinal direction and has an inner surface on which the plurality of ribs are formed, a first holder coupling portion which is formed such that a diameter thereof gradually increases from one end portion of the straight portion in the longitudinal direction and has an end portion coupled to the first holder, and a second holder coupling portion which is formed such that a diameter thereof gradually increases from the other end portion of the straight portion in the longitudinal direction and has an end portion coupled to the second holder.

Each of the plurality of ribs may extend intermittently in the longitudinal direction, and intermittent sections of each of the plurality of ribs may constitute the connection flow paths.

Each of the plurality of ribs may include a plurality of sub-ribs which protrude from the inner surface of the diaphragm body to be in contact with the outer surface of the outer tube and are disposed in a line to be spaced apart from each other in the longitudinal direction, each of the plurality of sub-ribs may be formed to have a predetermined length in the longitudinal direction and a predetermined width in the circumferential direction, and separation spaces between the plurality of sub-ribs may constitute the connection flow path.

The plurality of ribs may include first ribs and second ribs alternately disposed in the circumferential direction, each of the first ribs may include a plurality of first sub-ribs which protrude from the inner surface of the diaphragm body to be in contact with the outer surface of the outer tube and are disposed in a line to be spaced apart from each other in the longitudinal direction, each of the second ribs may include a plurality of second sub-ribs which protrude from the inner surface of the diaphragm body to be in contact with the outer surface of the outer tube and are disposed in a line to be spaced apart from each other in the longitudinal direction, and the plurality of first sub-ribs and the plurality of second sub-ribs may be obliquely disposed to be spaced apart from each other in the circumferential direction.

The plurality of second sub-ribs may be disposed such that a center of each of the second sub-ribs in the longitudinal direction and a center of a first separation space located in the longitudinal direction and corresponding to each of the second sub-ribs among first separation spaces between the plurality of first sub-ribs are arranged in a line in the circumferential direction, and the plurality of first sub-ribs may be disposed such that a center of each of the first sub-ribs in the longitudinal direction and a center of a second separation space located in the longitudinal direction and corresponding to each of the first sub-ribs among second separation spaces between the plurality of second sub-ribs are arranged in a line in the circumferential direction.

A length of each of the first sub-ribs may be 1.0 times to 5.0 times a length of the second separation space corresponding to each of the first sub-ribs, and a length of each of the second sub-ribs may be 1.0 times to 5.0 times a length of the first separation space corresponding to each of the second sub-ribs.

The plurality of first sub-ribs may have an equal length and may be spaced apart from each other at equal intervals, and the plurality of second sub-ribs may have an equal length and may be spaced apart from each other at equal intervals.

A length of the first separation space between the plurality of first sub-ribs may be 0.2 times to 1.0 times a length of any one of the plurality of first sub-ribs, and a length of the second separation space between the plurality of second sub-ribs may be 0.2 times to 1.0 times a length of any one of the plurality of second sub-ribs.

A length of the plurality of first sub-ribs may be equal to a length of the plurality of second sub-ribs, and the length of the first separation space between the plurality of first sub-ribs may be equal to the length of the second separation space between the plurality of second sub-ribs.

The plurality of first sub-ribs and the plurality of second sub-ribs may have an equal width, and a separation distance between the plurality of first sub-ribs and the plurality of second sub-ribs in the circumferential direction may be 0.5 times to 3.0 times a width of any one of the plurality of first sub-ribs and the plurality of second sub-ribs.

At least one sub-rib of the plurality of sub-ribs may be formed such that a central area thereof in the longitudinal direction has a predetermined width.

The at least one sub-rib may be formed such that a cross section thereof in a protruding direction has a quadrangular shape having round corners.

The at least one sub-rib may be formed such that a cross section thereof in a protruding direction has a capsule shape.

At least one sub-rib of the plurality of sub-ribs may be formed such that a width thereof increases and then decreases in the longitudinal direction.

The at least one sub-rib may be formed such that a cross section thereof in a protruding direction has a rhombus shape having round corners.

The at least one sub-rib may be formed to have a hexagonal shape which has a symmetrical structure in a width direction, of which a pair of sides facing each other are located at both end portions in the longitudinal direction, and of which corners are round.

Each of the plurality of ribs may include a single body continuously extending in the longitudinal direction, and a through-hole passing though the single body in the circumferential direction may be formed and may constitute the connection flow path.

The through-hole formed in the single body may be provided as a plurality of through-holes, and the plurality of through-holes may be formed to be spaced apart from each other in the longitudinal direction.

The plurality of ribs may include first ribs and second ribs alternately disposed in the circumferential direction, each of the first ribs may include a first single body continuously extending in the longitudinal direction, a plurality of first through-holes passing through the first single body in the circumferential direction may be formed to be spaced apart from each other in the longitudinal direction, each of the second ribs may include a second single body continuously extending in the longitudinal direction, a plurality of second through-holes passing through the second single body in the circumferential direction may be formed to be spaced apart from each other in the longitudinal direction, and the plurality of first through-holes and the plurality of second through-holes may be obliquely disposed to be spaced apart from each other in the circumferential direction.

According to another aspect of the present disclosure, there is provided a self-levelizer damper including the diaphragm.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a longitudinal cross-sectional view of a self-levelizer damper according to one embodiment of the present disclosure;

FIG. 2 is a view illustrating a diaphragm, a first holder, and a second holder according to one embodiment of the present disclosure;

FIG. 3 is an enlarged view of part A of FIG. 1;

FIG. 4 is an enlarged view of part B of FIG. 1;

FIG. 5 is a view in a direction of an arrow of line C-C of FIG. 1;

FIG. 6 is a view in a direction of an arrow of line D-D of FIG. 1;

FIG. 7 is a view illustrating an inner surface of a portion of a diaphragm body in a developed state according to an embodiment of the present invention;

FIG. 8 is a view illustrating a modified example of a shape of a sub-rib shown in FIG. 7;

FIG. 9 is another modified example of a shape of a sub-rib shown in FIG. 7;

FIG. 10 is still another modified example of a shape of a sub-rib shown in FIG. 7;

FIG. 11 is a longitudinal cross-sectional view of a diaphragm according to another embodiment of the present disclosure;

FIG. 12 is a view in a direction of an arrow of line E-E of FIG. 11;

FIG. 13 is a view in a direction of an arrow of line F-F of FIG. 11; and

FIG. 14 is a view illustrating an inner surface of a portion of a diaphragm body in a developed state according to another embodiment of the present invention.

### DETAILED DESCRIPTION OF EXEMPLARY EMBODIMENTS

Hereinafter, embodiments of the present disclosure will be described in detail with reference to the accompanying drawings so that those skilled in the art may easily practice the present disclosure. It should be understood that the present disclosure may be embodied in different ways and is not limited to the following embodiments. In order to clearly describe the present disclosure, portions not related to the description will be omitted from the drawings. Like components will be denoted by like reference numerals throughout the specification.

The words and terms used in the present specification and claims should not be construed as being limited to conventional or dictionary meanings and should be interpreted with meanings and concepts consistent with the technical idea of the present disclosure on the basis of the principle that an inventor can properly define the concepts of terms in order to explain his or her disclosure in the best way.

Therefore, the embodiments described in the present specification and the configurations illustrated in the drawings are only exemplary embodiments of the present disclosure and do not represent all the technical ideas of the present disclosure, and thus it should be understood that there may be various equivalents and variations that can replace them at the time of application.

As used herein, the word “comprise” or “have” is used to specify the existence of a feature, number, process, operation, constituent element, part, or combination thereof, and it will be understood that the existence or additional possibility of one or more other features, numbers, processes, operations, constituent elements, parts, or combinations thereof is not excluded in advance.

Unless there are special circumstances, a case in which a component is disposed “in front of,” “behind,” “above,” or “below” another component includes not only a case in which the component is disposed directly “in front of,” “behind,” “above,” or “below” the other component, but also a case in which still another component is disposed therebetween. In addition, unless there are special circumstances, a case in which a component is “connected” to another component includes not only a case in which the component is directly connected to the other component, but also a case in which the component is indirectly connected to the other component.

Hereinafter, a diaphragm and a self-levelizer damper including the same according to one embodiment of the present disclosure will be described with reference to the accompanying drawings.

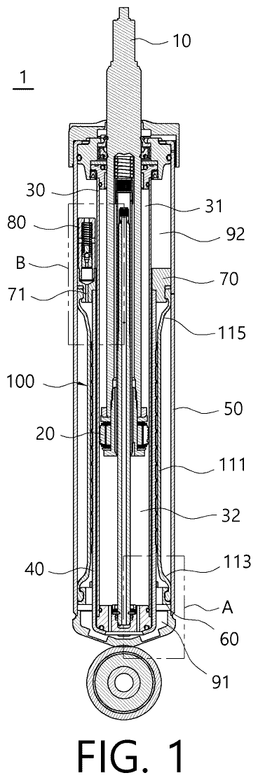

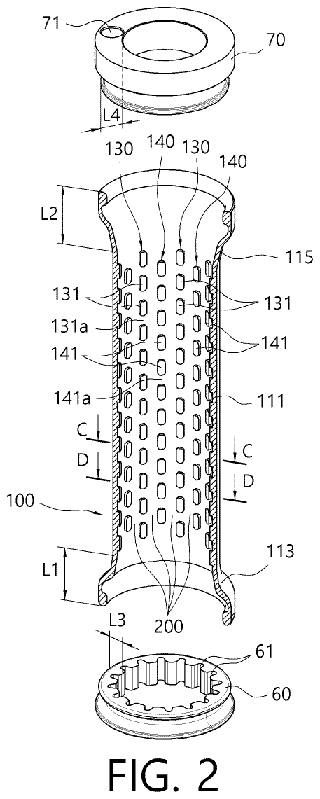

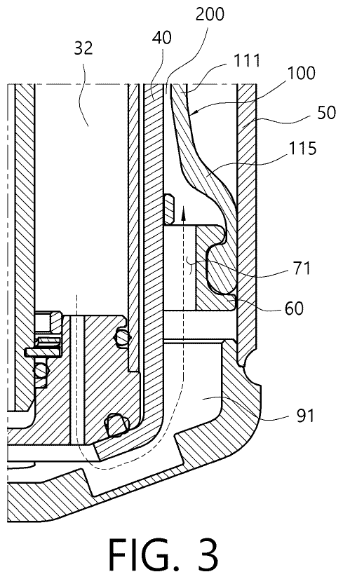

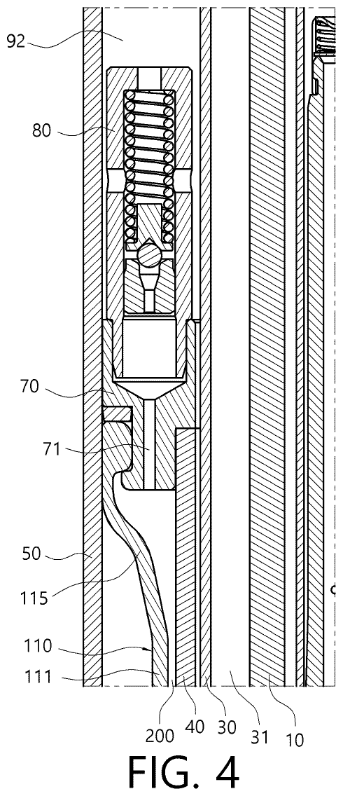

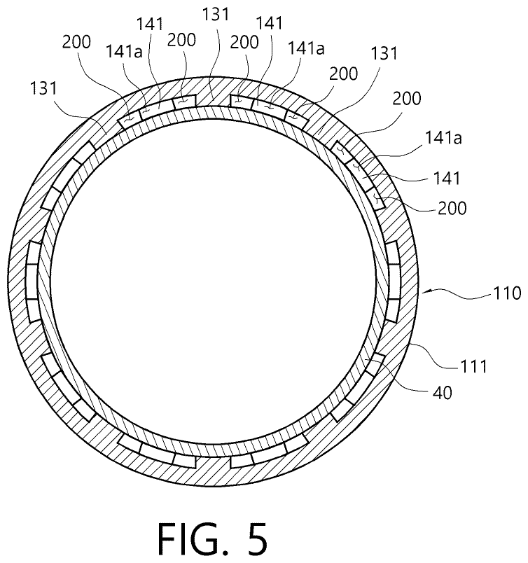

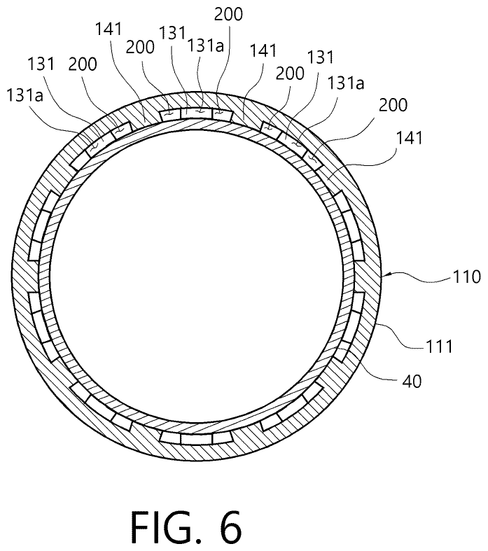

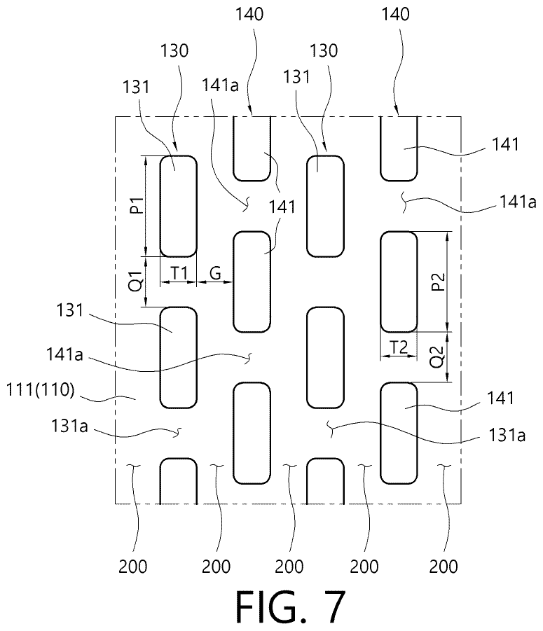

FIG. 1 is a longitudinal cross-sectional view of a self-levelizer damper according to one embodiment of the present disclosure. FIG. 2 is a view illustrating a diaphragm, a first holder, and a second holder according to one embodiment of the present disclosure. In FIG. 2, the diaphragm is shown in a longitudinal cross-sectional view. FIG. 3 is an enlarged view of part A of FIG. 1. FIG. 4 is an enlarged view of part B of FIG. 1. FIG. 5 is a view in a direction of an arrow of line C-C of FIG. 1. FIG. 6 is a view in a direction of an arrow of line D-D of FIG. 1. FIG. 7 is a view illustrating an inner surface of a portion of a diaphragm body in a developed state according to an embodiment of the present invention.

For reference, as shown in FIG. 1, a vehicle body (not shown) is located above a self-levelizer damper 1, and an axle (not shown) is located below the self-levelizer damper 1.

Referring to FIGS. 1 to 7, the self-levelizer damper 1 according to one embodiment of the present disclosure includes a piston rod 10, a piston valve 20, an inner tube 30, an outer tube 40, a cylinder 50, a first holder 60, a second holder 70, a diaphragm 100, and a relief valve 80.

The piston rod 10 extends to a predetermined length. One end portion of the piston rod 10 is coupled to the vehicle body, and the piston valve 20 is coupled to the other end portion of the piston rod 10.

The inner tube 30 extends to a predetermined length. The inner tube 30 guides the movement of the piston valve 20 and is filled with oil. The inner tube 30 extends in the same direction as the piston rod 10. In this case, a longitudinal direction of the inner tube 30 may coincide with an axial direction of the piston rod 10.

An internal space of the inner tube 30 may be divided into a first chamber 31 and a second chamber 32 by the piston valve 20. Sizes of the first chamber 31 and the second chamber 32 may vary according to a position of the piston valve 20 inside the inner tube 30.

For example, as shown in FIG. 1, the first chamber 31 is located above the piston valve 20, and the second chamber 32 is located below the piston valve 20. In this case, the first chamber 31 is disposed closer to the vehicle body (not shown) than the second chamber 32.

The outer tube 40 extends to a predetermined length. The outer tube 40 extends in the same direction as the inner tube 30. In this case, a longitudinal direction of the outer tube 40 may coincide with the longitudinal direction of the inner tube 30. The outer tube 40 surrounds the inner tube 30.

The cylinder 50 extends to a predetermined length. The cylinder 50 extends in the same direction as the outer tube 40. In this case, an axial or longitudinal direction of the cylinder 50 may coincide with the longitudinal direction of the outer tube 40.

The first holder 60 is connected to one end portion of the outer tube 40 of the longitudinal direction and is disposed between the outer tube 40 and the cylinder 50.

A first holder flow path 61 is formed in the first holder 60. Oil of a high-pressure chamber 91 may flow in between the outer tube 40 and the cylinder 50 through the first holder flow path 61. The first holder flow path 61 may be provided as a plurality of first holder flow paths 61, and the plurality of first holder flow paths 61 may be formed in an inner surface of the first holder to be spaced apart from each other in a circumferential direction.

The second holder 70 is connected to the other end portion of the outer tube 40 in the longitudinal direction and is disposed between the outer tube 40 and the cylinder 50. A second holder flow path 71 is formed in the second holder 70. The second holder flow path 71 is connected to the relief valve 80 to be described below.

Oil introduced from the high-pressure chamber 91 to a portion between the outer tube 40 and the cylinder 50 through the first holder 60 may pass through the second holder flow path 71 and the relief valve 80 to move to a low-pressure chamber 92.

The relief valve 80 may be coupled to the second holder 70. The relief valve 80 is installed to be connected to the second holder flow path 71 in the second holder 70.

When the pressure in the high-pressure chamber 91 increases excessively, the relief valve 80 is opened to allow oil of the high-pressure chamber 91 to be discharged to the low-pressure chamber 92, thereby serving to manage the maximum pressure of the high-pressure chamber 91.

For example, during a compression stroke (bump stroke) in which the piston valve 20 is lowered, oil located in the second chamber 32 moves to the first chamber 31 and the high-pressure chamber 91, and during an extension stroke (rebound stroke) in which the piston valve 20 is lifted, oil located in the first chamber 31 and the high-pressure chamber 91 moves to the second chamber 32 and the low-pressure chamber 92, thereby allowing the self-levelizer damper 1 to exert a damping force during bump and rebound.

When the compression stroke of the piston valve 20 continues and the pressure of the high-pressure chamber 91 increases, a position of the piston valve 20 is lifted in an opposite direction to adjust a height of a vehicle. In this case, when the pressure of the high-pressure chamber 91 increases excessively, the relief valve 80 is opened to allow the pressure of the high-pressure chamber 91 to be transmitted to the low-pressure chamber 92 so that the pressure of the high-pressure chamber 91 at a certain level is appropriately maintained.

The diaphragm 100 is located in a space between the outer tube 40 and the cylinder 50, and one end portion and the other end portion thereof in a longitudinal direction are connected to the first holder 60 and the second holder 70, respectively.

The diaphragm 100 may be formed of a cylindrical tube. The diaphragm 100 may include an elastic material, for example, a rubber material. The diaphragm 100 forms a flow path 200 for oil that is discharged from the high-pressure chamber 91 and flows toward the low-pressure chamber 92.

Oil discharged through the first holder flow path 61 formed in the first holder 60 moves toward the second holder 70 through the flow path 200 provided in the diaphragm 100.

In one embodiment of the present disclosure, the diaphragm 100 includes a diaphragm body 110 with a tube shape extending in a longitudinal direction and a plurality of ribs 130 and 140 formed to protrude from an inner surface of the diaphragm body 110.

The diaphragm body 110 is formed of a cylindrical tube. The diaphragm body 110 extends in the longitudinal direction. The longitudinal direction of the diaphragm body 110 is the same as the longitudinal direction of the outer tube 40, the cylinder 50, and the like. The diaphragm body 110 may be made of an elastic material such as rubber.

The diaphragm body 110 may include a straight portion 111, a first holder coupling portion 113, and a second holder coupling portion 115.

The straight portion 111 is formed of a cylindrical tube with a constant diameter in a longitudinal direction. The plurality of ribs 130 and 140 are formed on an inner surface of the straight portion 111. The plurality of ribs 130 and 140 form the flow path 200. This will be described below.

The first holder coupling portion 113 is formed such that a diameter thereof gradually increases in a longitudinal direction from one end portion of the straight portion 111, and an end portion thereof is coupled to the first holder 60.

The second holder coupling portion 115 is formed such that a diameter thereof gradually increases in a longitudinal direction from the other end portion of the straight portion 111, and an end portion thereof is coupled to the second holder 70.

In the diaphragm body 110, a length L1 of the first holder coupling portion 113 may be greater than a difference L3 between an inner diameter and an outer diameter of a surface of the first holder 60 facing the second holder 70.

In this case, even when the diaphragm body 110 is deformed by oil pressure, since the first holder coupling portion 113 is prevented from coming into contact with the surface of the first holder 60 facing the second holder 70, the opening of the flow path 200 facing the high-pressure chamber 91 may always be maintained, and in particular, the first holder coupling portion 113 may be prevented from being damaged by coming into contact with the first holder 60.

In order to prevent the first holder coupling portion 113 from coming into contact with the first holder 60 when the diaphragm body 110 is deformed due to oil pressure, it is preferable that the length L1 of the first holder coupling portion 113 be at least twice the difference L3 between the inner diameter and the outer diameter of the surface of the first holder 60 facing the second holder 70, but the present disclosure is not limited thereto.

In the diaphragm body 110, a length L2 of the second holder coupling portion 115 may be greater than a difference L4 between an inner diameter and an outer diameter of a surface of the second holder 70 facing the first holder 60.

In this case, even when the diaphragm body 110 is deformed by oil pressure, since the second holder coupling portion 115 is prevented from coming into contact with the surface of the second holder 70 facing the first holder 60, the opening of the flow path 200 facing the low-pressure chamber 92 may always be maintained.

In order to prevent the second holder coupling portion 115 from coming into contact with the second holder 70 when the diaphragm body 110 is deformed due to oil pressure, it is preferable that the length L2 of the second holder coupling portion 115 be at least twice the difference L4 between the inner diameter and the outer diameter of the surface of the second holder 70 facing the first holder 60, but the present disclosure is not limited thereto.

The plurality of ribs 130 and 140 extend in a longitudinal direction of the diaphragm body 110 or the straight portion 111 and protrude from the inner surface of the diaphragm body 110, specifically, the inner surface of the straight portion 111, to be in contact with an outer surface of the outer tube 40.

In this case, the plurality of ribs 130 and 140 form a plurality of flow paths 200 extending in a longitudinal direction between the outer surface of the outer tube 40 and the inner surface of the straight portion 111.

The plurality of ribs 130 and 140 are disposed apart from each other in a circumferential direction of the diaphragm body 110 or the straight portion 111, and the plurality of flow paths 200 are disposed to be spaced apart from each other in the circumferential direction. Here, the “circumferential direction” of the diaphragm body 110 or the straight portion 111 may be replaced with the term “peripheral direction.”

In this case, the plurality of ribs 130 and 140 and the plurality of flow paths 200 may be alternately disposed in the circumferential direction.

Hereinafter, when no specific subject is described in relation to the “longitudinal direction” and “circumferential direction” used to describe the plurality of ribs 130 and 140 and the plurality of flow paths 200, the “longitudinal direction” and “circumferential direction” are the “longitudinal direction” and the “circumferential direction” of the diaphragm body 110 or the straight portion 111.

When the pressure of the high-pressure chamber 91 increases due to a compression stroke of the piston valve 20, the oil pressure of the high-pressure chamber 91 passes through the first holder 60 and then is transmitted to the first holder coupling portion 113 of the diaphragm body 110 in a direction of a dotted arrow shown in FIG. 3, and there is a possibility that the straight portion 111 of the diaphragm body 110 may be contracted and deformed by the transmitted oil pressure.

In this case, the plurality of ribs 130 and 140, which are formed to protrude from the inner surface of the straight portion 111 and are in contact with the outer surface of the outer tube 40, support the inner surface of the straight portion 111 not to be in close contact with the outer surface of the outer tube 40 and also provide the flow path 200, thereby allowing oil of the high-pressure chamber 91 to smoothly move toward the low-pressure chamber 92.

Accordingly, damage to parts and noise generation in the self-levelizer damper 1 can be prevented.

In one embodiment of the present disclosure, the plurality of ribs 130 and 140 may be disposed to be spaced apart from each other at equal intervals in the circumferential direction. In this case, the plurality of ribs 130 and 140 and the plurality of flow paths 200 formed by the plurality of ribs 130 and 140 may have a symmetrical structure so that the flow of oil through the flow path 200 can be stabilized and uniformized.

Alternatively, although not shown, one or more of the plurality of ribs 130 and 140 may be disposed to have a different interval from other ribs 130 and 140 in the circumferential direction.

According to one embodiment of the present disclosure, a connection flow path for connecting the flow path 200 to another flow path 200 adjacent thereto in the circumferential direction may be provided in each of the ribs 130 and 140 spaced apart from each other in the circumferential direction to form the flow path 200. The connection flow path may have a hole or channel shape passing through each of the ribs 130 and 140 in the circumferential direction.

For example, when the straight portion 111 is partially deformed due to excessive pressure, the inner surface of the straight portion 111 may partially come into close contact with the outer surface of the outer tube 40. In this case, at least one flow path 200 of the plurality of flow paths 200 may be blocked.

In this case, oil moving through a blocked flow path may flow into another adjacent flow path through a connection flow path formed in a pair of ribs 130 and 140 defining the blocked flow path. In other words, the connection flow path functions as a bypass for the blocked flow path.

When the connection flow path is provided in each of the ribs 130 and 140, a sudden pressure increase caused by a blocked flow path can be prevented so that the self-levelizer damper 1 can perform stable operation.

According to one embodiment of the present disclosure, each of the plurality of ribs 130 and 140 intermittently extends in the longitudinal direction.

In this case, intermittent sections of each of the ribs 130 and 140 form connection flow paths connecting adjacent flow paths 200 in the circumferential direction.

The plurality of ribs 130 and 140 include a plurality of sub-ribs 131 and 141 disposed in a line in the longitudinal direction.

The plurality of sub-ribs 131 and 141 constituting the ribs 130 and 140 protrude from the inner surface of the diaphragm body 110, specifically, the inner surface of the straight portion 111, to be in contact with the outer surface of the outer tube 40, and are disposed in a line to be spaced apart from each other in the longitudinal direction of the diaphragm body 110, specifically, the longitudinal direction of the straight portion 111.

The sub-ribs 131 and 141 have a columnar shape that protrudes from the inner surface of the straight portion 111 toward the outer surface of the outer tube 40. In this case, the sub-ribs 131 and 141 may protrude from the inner surface of the straight portion 111 by a predetermined height.

Separation spaces 131a and 141a between the plurality of sub-ribs 131 and 141 constituting the ribs 130 and 140 are intermittent sections and form connection flow paths connecting adjacent flow paths 200.

Each of the plurality of sub-ribs 131 and 141 constituting the ribs 130 and 140 may have a predetermined length in the longitudinal direction of the straight portion 111 and a predetermined width in the circumferential direction of the straight portion 111.

In one embodiment of the present disclosure, the plurality of sub-ribs 131 and 141 constituting the ribs 130 and 140 may all have the same length and width. Alternatively, although not shown, at least one of the plurality of sub-ribs constituting the ribs may have a different length and width from the rest.

In one embodiment of the present disclosure, the lengths of the separation spaces 131a and 141a between the plurality of sub-ribs 131 and 141 constituting the ribs 130 and 140 may all be the same. Alternatively, although not shown, at least one of the separation spaces between the plurality of sub-ribs constituting the ribs may have a different length from the rest.

In one embodiment of the present disclosure, the plurality of ribs 130 and 140 may include first ribs 130 and second ribs 140 that are alternately disposed in the circumferential direction. In this case, one second rib 140 may be disposed between a pair of first ribs 130 adjacent to each other in the circumferential direction, and one first rib 130 may be disposed between a pair of second ribs 140 adjacent to each other in the circumferential direction.

In one embodiment of the present disclosure, a plurality of first ribs 130 and a plurality of second ribs 140 are provided.

In one embodiment of the present disclosure, the first rib 130 includes a plurality of first sub-ribs 131 that protrude from the inner surface of the diaphragm body 110, specifically, the inner surface of the straight portion 111, to be in contact with the outer surface of the outer tube 40, and are disposed in a line to be spaced apart from each other in the longitudinal direction.

First separation spaces 131a between the plurality of first sub-ribs 131 constituting the first rib 130 are intermittent sections and constitute connection flow paths connecting adjacent flow paths 200.

The second rib 140 includes a plurality of second sub-ribs 141 that protrude from the inner surface of the diaphragm body 110, specifically, the inner surface of the straight portion 111, to be in contact with the outer surface of the outer tube 40, and are disposed in a line to be spaced apart from each other in the longitudinal direction.

Second separation spaces 141a between the plurality of second sub-ribs 141 constituting the second rib 140 are intermittent sections and constitute connection flow paths connecting adjacent flow paths 200.

The plurality of first sub-ribs 131 constituting the first rib 130 and the plurality of second sub-ribs 141 constituting the second rib 140 may be obliquely disposed to be spaced apart from each other in the circumferential direction.

In other words, the plurality of first sub-ribs 131 constituting the first rib 130 and the plurality of second sub-ribs 141 constituting the second rib 140 may be disposed adjacent to each other in a zigzag form in the longitudinal direction.

In this case, the first separation space 131a which is a connection flow path provided in the first rib 130 and the second separation space 141a which is a connection flow path provided in the second rib 140 may be obliquely disposed to be spaced apart from each other in the circumferential direction.

In other words, the first separation space 131a which is the connection flow path provided in the first rib 130 and the second separation space 141a which is the connection flow path provided in the second rib 140 are disposed adjacent to each other in a zigzag form in the longitudinal direction.

In this case, oil moving along the flow path 200 formed between the first rib 130 and the second rib 140 moves to alternately encounter the first separation space 131a which is the connection flow path provided in the first rib 130 and the second separation space 141a which is the connection flow path provided in the second rib 140.

In this case, oil moving along the flow path 200 formed between the first rib 130 and the second rib 140 alternately encounters two different flow paths 200 through connection flow paths with which the oil moves.

In this case, oil moving along the flow path 200 formed between the first rib 130 and the second rib 140 may flow more smoothly along the flow path 200 as compared to a case in which the oil moves to simultaneously encounter the connection flow path provided in the first rib 130 and the connection flow path provided in the second rib 140.

Furthermore, the diaphragm body 110 may be partially deformed due to excessive pressure, and thus a certain flow path 200 formed between the first rib 130 and the second rib 140 may be blocked at a specific portion in the longitudinal direction.

In this case, even when any one located at the specific portion in the longitudinal direction among the connection flow path of the first rib 130 and the connection flow path of the second rib 140 is blocked, the other one not located at the specific portion in the longitudinal direction may remain open, and thus oil of the certain flow path 200 may be smoothly diverted.

In one embodiment of the present disclosure, the plurality of first sub-ribs 131 constituting the first rib 130 may be disposed such that a center of each first sub-rib 131 in the longitudinal direction and a center of the second separation space 141a located in the longitudinal direction and corresponding to each first sub-rib 131 among the second separation spaces 141a between the plurality of second sub-ribs 141 are arranged in a line in the circumferential direction.

The plurality of second sub-ribs 141 constituting the second rib 140 may be disposed such that a center of each second sub-rib 141 in the longitudinal direction and a center of the first separation space 131a corresponding to each first sub-rib 131 among the first separation spaces 131a between the plurality of first sub-ribs 131 are arranged in a line in the circumferential direction.

In this case, the first separation space 131a and the second separation space 141a may be regularly disposed in a zigzag form along the flow path 200. In this case, the flow of oil moving along the flow path 200 may be regular and smooth.

Referring to FIG. 7, a length P1 of each first sub-rib 131 may be 1.0 times to 5.0 times a length Q2 of the second separation space 141a corresponding to each first sub-rib 131. Here, each first sub-rib 131 and the second separation space 141a corresponding thereto are disposed to face each other in the circumferential direction.

For reference, as shown in FIG. 7, a vertical direction is the longitudinal direction of the diaphragm body 110 or the straight portion 111, and a lateral direction is the circumferential direction (or the peripheral direction) of the diaphragm body 110 or the straight portion 111.

When the length P1 of the first sub-rib 131 is less than 1.0 times the length Q2 of the corresponding second separation space 141a, the second separation space 141a serving as a bypass may become too large, and thus the flow of oil moving along the flow path 200 may not be smooth.

Furthermore, when the length P1 of the first sub-rib 131 exceeds 5.0 times the length Q2 of the corresponding second separation space 141a, the second separation space 141a serving as a bypass may become too small, and thus a function of the second separation space 141a as a bypass may be degraded.

Furthermore, a length P2 of each second sub-rib 141 may be 1.0 times to 5.0 times a length Q1 of the first separation space 131a corresponding to each second sub-rib 141. Here, each second sub-rib 141 and the first separation space 131a corresponding thereto are disposed to face each other in the circumferential direction.

When the length P2 of the second sub-rib 141 is less than 1.0 times the length Q1 of the corresponding first separation space 131a, the second separation space 141a serving as a bypass may become too large, and thus the flow of oil moving along the flow path 200 may not be smooth.

Furthermore, when the length P2 of the second sub-rib 141 exceeds 5.0 times the length Q1 of the corresponding first separation space 131a, the first separation space 131a serving as a bypass may become too small, and thus a function of the first separation space 131a as a bypass may be degraded.

Referring to FIG. 7, the plurality of first sub-ribs 131 may have the equal length P1. The plurality of first sub-ribs 131 may be disposed to be spaced apart from each other at equal intervals Q1. In this case, the lengths Q1 of the first separation spaces 131a between the plurality of first sub-ribs 131 are equal to each other.

Furthermore, the plurality of second sub-ribs 141 may have the equal length P2. The plurality of second sub-ribs 141 may be disposed to be spaced apart from each other at equal intervals Q2. In this case, the lengths Q2 of the second separation spaces 141a between the plurality of second sub-ribs 141 are equal to each other.

In this way, when the plurality of first sub-ribs 131 have the equal length and are disposed to be spaced apart from each other at equal intervals and the plurality of second sub-ribs 141 have the equal length and are disposed to be spaced apart from each other at equal intervals, the flow of oil flowing along the flow path 200 may have predetermined consistency and regularity.

In this case, the length Q1 of the first separation space 131a between the plurality of first sub-ribs 131 constituting the first rib 130 may be 0.2 times to 1.0 times the length P1 of any one of the plurality of first sub-ribs 131.

When the length Q1 of the first separation space 131a is less than 0.2 times the length P1 of the first sub-rib 131, the first separation space 131a serving as a bypass may become too small, and thus a function of the first separation space 131a as a bypass may be degraded.

When the length Q1 of the first separation space 131a exceeds 1.0 times the length P1 of the first sub-rib 131, the first separation space 131a serving as a bypass becomes too large, and the flow of oil moving along the flow path 200 may not be smooth.

Furthermore, the length Q2 of the second separation space 141a between the plurality of second sub-ribs 141 constituting the second rib 140 may be 0.2 times to 1.0 times the length P2 of any one of the plurality of second sub-ribs 141.

When the length Q2 of the second separation space 141a is less than 0.2 times the length P2 of the second sub-rib 141, the second separation space 141a serving as a bypass may become too small, and thus a function of the second separation space 141a as a bypass be degraded.

When the length Q2 of the second separation space 141a exceeds 1.0 times the length P2 of the second sub-rib 141, the second separation space 141a serving as a bypass becomes too large, and thus the flow of oil moving along the flow path 200 may not be smooth.

Referring to FIG. 7, the length P1 of the plurality of first sub-ribs 131 constituting the first rib 130 may be equal to the length P2 of the plurality of second sub-ribs 141 constituting the second rib 140.

Furthermore, the length Q1 of the first separation space 131a between the plurality of first sub-ribs 131 constituting the first rib 130 may be equal to the length Q2 of the second separation space 141a between the plurality of second sub-ribs 141 constituting the second rib 140.

In this case, all of the sub-ribs 131 and 141 including the plurality of first sub-ribs 131 and the plurality of second sub-ribs 141 can have the same consistency and regularity in the longitudinal direction and circumferential direction of the diaphragm body 110 so that the flow of oil along the flow path 200 can have more improved consistency and regularity.

Referring to FIG. 7, a width T1 of the plurality of first sub-ribs 131 may be equal to a width T2 of the plurality of second sub-ribs 141. In other words, the plurality of first sub-ribs 131 and the plurality of second sub-ribs 141 may have the equal width.

In this case, a separation distance G between the plurality of first sub-ribs 131 and the plurality of second sub-ribs 141 in the circumferential direction may be 0.5 times to 3.0 times any one of the width T1 of the plurality of first sub-ribs 131 and the width T2 of the plurality of second sub-ribs 141.

When the separation distance G between the plurality of first sub-ribs 131 and the plurality of second sub-ribs 141 in the circumferential direction is less than 0.5 times any one of the width T1 of the plurality of first sub-ribs 131 and the width T2 of the plurality of second sub-ribs 141, a width G of the flow path 200 formed between the plurality of first sub-ribs 131 and the plurality of second sub-ribs 141 may be too small, and thus the flow of oil moving along the flow path 200 may not be smooth.

When the separation distance G between the plurality of first sub-ribs 131 and the plurality of second sub-ribs 141 in the circumferential direction exceeds 3.0 times any one width of the width T1 of the plurality of first sub-ribs 131 and the width T2 of the plurality of second sub-ribs 141, the width T1 or T2 of the first sub-rib 131 or the second sub-rib 141 may be less than the width G of the flow path 200, and thus a supporting force for supporting the inner surface of the straight portion 111 with respect to external pressure and maintaining the flow path 200 may be reduced.

In one embodiment of the present disclosure, at least one sub-rib 131 or 41 among the plurality of sub-ribs 131 and 141 constituting the ribs 130 and 140 may be formed such that a central area thereof in the longitudinal direction has a predetermined width.

For example, at least one sub-rib 131 or 141 is formed of a column having a quadrangular cross section with round corners shown in FIG. 7. In other words, at least one sub-rib 131 or 141 is formed such that a cross section thereof in a protruding direction has a quadrangular shape with round corners shown in FIG. 7. However, although not shown, the sub-rib may also be formed of a general column having a quadrangular cross section with angular corners.

The plurality of sub-ribs 131 and 141 constituting the ribs 130 and 140 may all have cross sections with the same shape shown in FIG. 7. In this case, the flow of oil along the flow path 200 can have improved consistency and regularity.

However, the plurality of sub-ribs 131 and 141 may not all have cross sections with the same shape

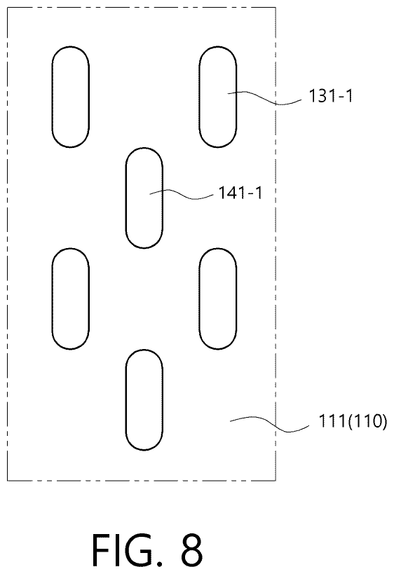

As another example, at least one sub-rib 131-1 or 141-1 may be formed such that a cross section thereof in a protruding direction has a capsule shape shown in FIG. 8. In other words, at least one sub-rib 131-1 or 141-1 may be formed of a column having a cross section in which both end portions of a rectangle are formed as semicircles shown in FIG. 8.

For reference, FIG. 8 is a view illustrating a modified example of a shape of a sub-rib shown in FIG. 7.

A plurality of sub-ribs 131-1 and 141-1 constituting the ribs may all have cross sections with the same shape as in FIG. 8, but the present disclosure is not limited thereto.

When the sub-ribs 131, 141, 131-1, and 141-1 are formed such that a central area thereof has a predetermined width in the longitudinal direction as described above, the flow of oil moving through the flow path 200 may be smooth due to the central area with a predetermined width.

Meanwhile, the sub-ribs 131, 141, 131-1, and 141-1 shown in FIGS. 7 and 8 have round corners, no eddy occurs in the flow of oil moving along the flow path 200 or the flow of oil diverted through the connection flow path, and thus the flow of oil becomes smoother.

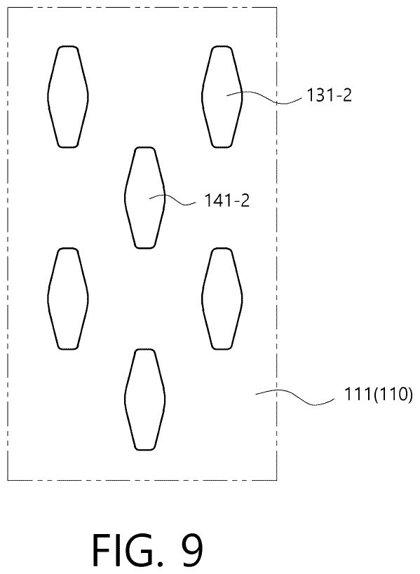

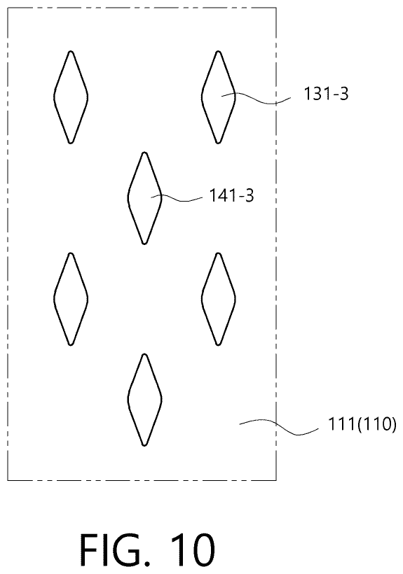

Alternatively, as shown in FIGS. 9 and 10, a plurality of sub-ribs 131-2, 141-2, 131-3, and 141-3 constituting the ribs may be formed such that a width thereof is increased or decreased in the longitudinal direction.

For reference, FIG. 9 is another modified example of a shape of a sub-rib shown in FIG. 7. FIG. 10 is still another modified example of a shape of a sub-rib shown in FIG. 7.

As an example, at least one sub-rib 131-3 or 141-3 may be formed of a column having a cross section with a rhombus shape having round corners shown in FIG. 10. In other words, at least one sub-rib 131-3 or 141-3 may be formed such that a cross section thereof in a protruding direction has a rhombus shape with round corners shown in FIG. 10. Although not shown, the sub-rib may also be formed of a column having a cross section with a general rhombus shape with angular corners.

A plurality of sub-ribs 131-3 and 141-3 constituting the ribs may all have cross sections with the same shape shown in FIG. 10, but the present disclosure is not limited thereto.

As another example, at least one sub-rib 131-2 or 141-2 may be formed to have a hexagonal shape in which a cross section thereof in a protruding direction has a symmetrical structure in a width direction, a pair of sides facing each other are located at both end portions in a longitudinal direction, and corners are round as shown in FIG. 9. Although not shown, the sub-rib may be formed to have a cross section with angular corners unlike that shown in FIG. 9.

A plurality of sub-ribs 131-2 and 141-2 constituting the ribs may all have cross sections with the same shape as in FIG. 9, but the present disclosure is not limited thereto.

In this way, when the sub-ribs 131-2, 141-2, 131-3, and 141-3 are formed such that a width thereof is increased and then decreased in a longitudinal direction, oil moving along the flow path 200 may move along side surfaces of the sub-ribs 131 and 141 in a width direction and may be smoothly diverted to another flow path 200 through the separation spaces 131a and 141a between a pair of sub-ribs 131 and 141 adjacent to each other in the longitudinal direction.

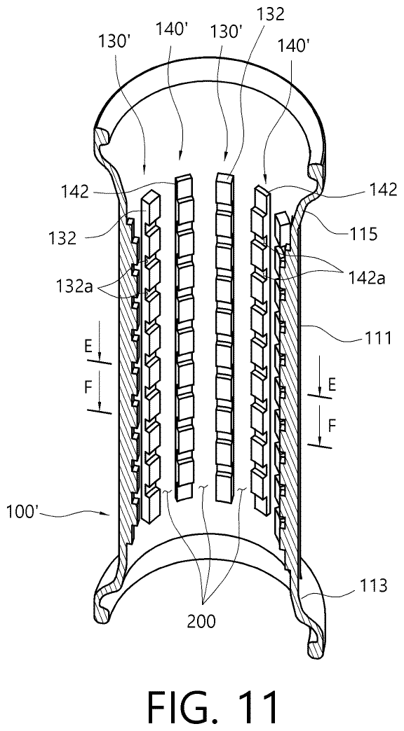

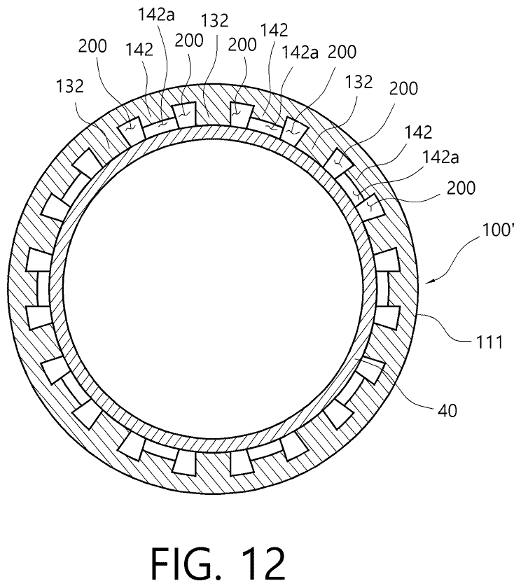

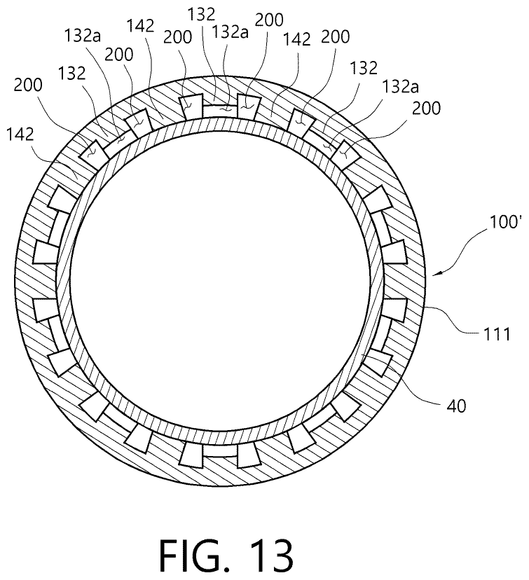

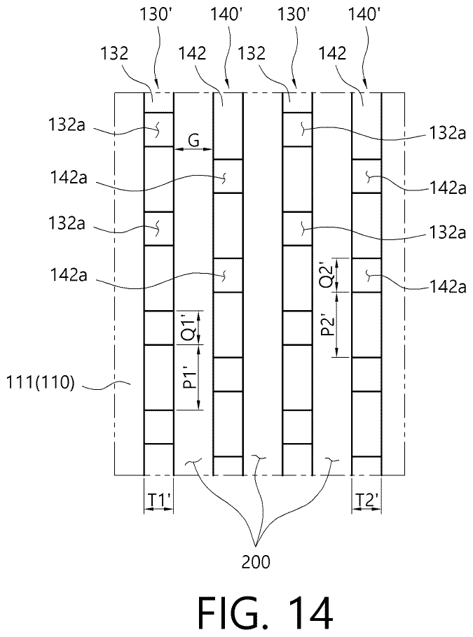

FIG. 11 is a longitudinal cross-sectional view of a diaphragm according to another embodiment of the present disclosure. FIG. 12 is a view in a direction of an arrow of line E-E of FIG. 11. FIG. 13 is a view in a direction of an arrow of line F-F of FIG. 11. FIG. 14 is a view illustrating an inner surface of a portion of a diaphragm body in a developed state according to another embodiment of the present invention.

Referring to FIGS. 11 to 14, a diaphragm 100′ according to another embodiment of the present disclosure includes a diaphragm body 110 and a plurality of ribs 130′ and 140′. The ribs 130′ and 140′ according to the present embodiment are different from the ribs 130 and 140 according to the above embodiment.

Hereinafter, the present embodiment will be described with a focus on the ribs 130′ and 140′.

The plurality of ribs 130′ and 140′ extend in a longitudinal direction of the diaphragm body 110 or a straight portion 111, protrude from an inner surface of the diaphragm body 110 to be in contact with an outer surface of an outer tube 40, and form a plurality of flow paths 200 extending in a longitudinal direction between the outer surface of the outer tube 40 and the inner surface of the diaphragm body 110 or the straight portion 111.

A connection flow path for connecting adjacent flow paths 200 to each other is provided in each of the plurality of ribs 130′ and 140′.

In the present embodiment, the ribs 130′ and 140′ include single bodies 132 and 142 continuously extending in a longitudinal direction.

Through-holes 132a and 142a passing through the single bodies 132 and 142 of the ribs 130′ and 140′ in a circumferential direction of the diaphragm body 110, specifically, in a circumferential direction of the straight portion 111, are formed. The through-holes 132a and 142a constitute the connection flow path connecting adjacent flow paths 200.

Hereinafter, when no specific subject is described in relation to the “longitudinal direction” and “circumferential direction” used to describe when the plurality of ribs 130′ and 140′ and a plurality of flow paths 200, the “longitudinal direction” and “circumferential direction” are the “longitudinal direction” and the “circumferential direction” of the diaphragm body 110 or the straight portion 111.

The through-holes 132a and 142a may be formed to pass through portions of protruding areas of the single bodies 132 and 142.

As an example, the through-holes 132a and 142a may be formed to pass through areas close to the outer tube 40 among the protruding areas of the single bodies 132 and 142 protruding from the inner surface of the straight portion 111. In this case, the through-holes 132a and 142a may be formed in a form in which side surfaces of the single bodies 132 and 142 in contact with the outer surface of the outer tube 40 are open.

In this case, the single bodies 132 and 142 are formed such that a protruding height of portions in which the through-holes 132a and 142a are formed is less than a protruding height of portions in which the through-holes 132a and 142a are not formed.

As another example, although not shown, the through-holes may be formed in a form in which an inner surface is completely closed.

In the present embodiment, a plurality of through-holes 132a and 142a may be formed in the single bodies 132 and 142 of the ribs 130′ and 140′. The plurality of through-holes 132a and 142a may be disposed to be spaced apart from each other in a longitudinal direction of the single bodies 132 and 142.

In this case, through-hole forming portions in which the through-holes 132a and 142a are formed and through-hole non-forming portions in which the through-holes 132a and 142a are not formed are alternatively formed in the single bodies 132 and 142 in the longitudinal direction. A plurality of through-hole forming portions and a plurality of through-hole non-forming portions may be formed.

The plurality of through-holes 132a and 142a formed in the single bodies 132 and 142 may have a predetermined length in the longitudinal direction and a predetermined width in the circumferential direction.

In the present embodiment, the plurality of ribs 130′ and 140′ may include first ribs 130′ and second ribs 140′ that are alternately disposed in the circumferential direction.

In this case, one second rib 140′ may be disposed between a pair of first ribs 130′ adjacent to each other in the circumferential direction, and one first rib 130′ may be disposed between a pair of second ribs 140′ adjacent to each other in the circumferential direction.

In the present embodiment of the present disclosure, a plurality of first ribs 130′ and a plurality of second ribs 140′ are provided.

In the present embodiment, the first rib 130′ includes a first single body 132 continuously extending in the longitudinal direction. A plurality of first through-holes 132a that pass through the first single body 132 in the circumferential direction of the straight portion 111 or a width direction of the first rib 130′ and are spaced apart from each other in the longitudinal direction may be formed. The first through-hole 132a constitutes a connection flow path connecting adjacent flow paths 200.

The second rib 140′ includes a second single body 142 continuously extending in the longitudinal direction. A plurality of first through-holes 142a that pass through the second single body 142 in the circumferential direction of the straight portion 111 or a width direction of the second rib 140′ and are spaced apart from each other in the longitudinal direction may be formed. The second through-hole 142a constitutes a connection flow path connecting adjacent flow paths 200.

The plurality of first through-holes 132a and the plurality of second through-holes 142a may be obliquely disposed to be spaced apart from each other in the circumferential direction of the diaphragm body 110.

In other words, the plurality of first through-holes 132a and the plurality of second through-holes 142a may be disposed adjacent to each other in a zigzag formed in the longitudinal direction of the diaphragm body 110.

In this case, oil moving along the flow path 200 formed between the first rib 130′ and the second rib 140′ moves to alternately encounter the first through-hole 132a which is a connection flow path provided in the first rib 130′ and the second through-hole 142a which is a connection flow path provided in the second rib 140′.

In the present embodiment, the first rib 130′ may be formed such that a center of each first through-hole 132a in the longitudinal direction and a center of a second through-hole non-forming portion located in the longitudinal direction and corresponding to each first through-hole 132a among a plurality of second through-hole non-formed portions of the second rib 140′ are arranged in a line in the circumferential direction.

The second rib 140′ may be formed such that a center of each second through-hole 142a in the longitudinal direction and a center of a first through-hole non-forming portion located in the longitudinal direction and corresponding to each second through-hole 142a among a plurality of first through-hole non-forming portions of the first rib 130′ are arranged in a line in the circumferential direction.

Referring to FIG. 14, a length Q1′ of each first through-hole 132a may be 1.0 times to 5.0 times a length P2′ of the second through-hole non-forming portion corresponding to each first through-hole 132a.

A length Q2′ of each second through-hole 142a may be 1.0 times to 5.0 times a length P1′ of the first through-hole non-forming portion corresponding to each second through-hole 132a.

Referring to FIG. 14, the plurality of first through-holes 132a may have the equal length Q1′. The plurality of first through-holes 132a may be disposed at equal intervals P1′ in the longitudinal direction. In other words, the plurality of first through-hole non-forming portions may have the equal length P1′.

The plurality of second through-holes 142a may have the equal length Q2′. The plurality of second through-holes 142a may be disposed to be spaced apart from each other at equal intervals P2′ in the longitudinal direction. In other words, the plurality of second through-hole non-forming portions may have the equal length P2′.

In this case, the length Q1′ of the plurality of first through-holes 132a may be 0.2 times to 1.0 times the length P1′ of any one of the plurality of first through-hole non-forming portions. The length Q2′ of the plurality of second through-holes 142a may be 0.2 times to 1.0 times the length P2′ of any one of the plurality of second through-hole non-forming portions.

In this case, the length Q1′ of the plurality of first through-holes 132a may be equal to the length Q2′ of the plurality of second through-holes 142a. The length P1′ of the plurality of first through-hole non-forming portions may be equal to the length P2′ of the plurality of second through-hole non-forming portions.

Referring to FIG. 14, a width T1′ of the first rib 130′ may be equal to a width T2′ of the second rib 140′. In this case, the first through-hole 132a and the second through-hole 142a may have the equal width. The first through-hole non-forming portion and the second through-hole non-forming portion may also have the equal width.

A separation distance G between the first rib 130′ and the second rib 140′ in the circumferential may be 0.5 times to 3.0 times the width T1′ of the first rib 130′ or the width T2′ of the second rib 140′.

According to the embodiments of the present disclosure as described above, in diaphragms 100 and 100′, a plurality of ribs 130, 140, 130′, and 140′ are formed to protrude from an inner surface of a diaphragm body 110, are disposed to be spaced apart from each other in a circumferential direction, and extend in a longitudinal direction, thus forming a plurality of flow paths 200 between an outer surface of an outer tube 40 and the inner surface of the diaphragm body 110, and therefore even when the diaphragm body 110 is deformed by oil pressure, the flow path 200 may be maintained so that oil may smoothly move from a high-pressure chamber to a low-pressure chamber.

Furthermore, according to one embodiment of the present disclosure, in diaphragms 100 and 100′, since a connection flow path passes through a plurality ribs 130, 140, 130′, and 140′ in a circumferential direction to connect flow paths 200 adjacent to each other in the circumferential direction, even when at least one of a plurality of flow paths 200 is blocked, oil moving through the blocked flow path 200 may be diverted to another neighboring flow path 200 through the connection flow path.

Accordingly, a sudden pressure increase caused by a blocked flow path 200 can be prevented, and a self-levelizer damper 1 can perform stable operation.

According to such a configuration, in a diaphragm according to an aspect of the present disclosure, a plurality of ribs are formed to protrude from an inner surface of a diaphragm body, are disposed to be spaced apart from each other in a circumferential direction, and extend in a longitudinal direction, thus forming a plurality of flow paths between an outer surface of an outer tube and an inner surface of the diaphragm body, and therefore even when the diaphragm body is deformed by oil pressure, the flow path can be maintained so that oil can smoothly move from a high-pressure chamber to a low-pressure chamber.

Furthermore, according to one embodiment of the present disclosure, since a diaphragm incudes a connection flow path that passes through a plurality of ribs in a circumferential direction to connect flow paths, which are adjacent to each other in the circumferential direction, to each other, even when at least one flow path of a plurality of flow paths blocked, oil moving through the blocked flow path can be diverted to another adjacent flow path through the connection flow path. Therefore, a sudden pressure increase caused by a blocked flow path can be prevented, and a self-levelizer damper can perform stable operation.

The effects of the present disclosure are not limited to the above effects and should be understood to include all effects that may be inferred from the configuration of the present disclosure described in the detailed description or claims of the present disclosure.

While the present disclosure has been described with reference to embodiments thereof, the spirit of the present disclosure is not limited to the embodiments presented in the present specification. Those skilled in the art who understand the spirit of the present disclosure may easily suggest other embodiments by adding, changing, or deleting components within the scope of the same concept, and the other embodiments are also within the spirit of the present disclosure.

What is claimed is:

1. A diaphragm which is a diaphragm for a self-levelizer damper including an outer tube, a cylinder configured to surround the outer tube, and a first holder and a second holder spaced apart from each other between the outer tube and the cylinder, the diaphragm comprising;
a diaphragm body which has a tube shape extending in a longitudinal direction and is disposed between the outer tube and the cylinder and of which both end portions in the longitudinal direction are coupled to the first holder and the second holder; and
a plurality of ribs which extend in the longitudinal direction, protrude from an inner surface of the diaphragm body to be in contact with an outer surface of the outer tube, and form a plurality of flow paths extending in the longitudinal direction between the outer surface of the outer tube and the inner surface of the diaphragm body,
wherein the plurality of ribs and the plurality of flow paths are alternatively disposed in a circumferential direction of the diaphragm body, and
connection flow paths are provided in the plurality of ribs to connect the flow paths adjacent to each other in the circumferential direction.

2. The diaphragm of claim 1, wherein the diaphragm body includes:
a straight portion which is formed of a cylindrical tube having a constant diameter in the longitudinal direction and has an inner surface on which the plurality of ribs are formed;
a first holder coupling portion which is formed such that a diameter thereof gradually increases from one end portion of the straight portion in the longitudinal direction and has an end portion coupled to the first holder; and
a second holder coupling portion which is formed such that a diameter thereof gradually increases from the other end portion of the straight portion in the longitudinal direction and has an end portion coupled to the second holder.

3. The diaphragm of claim 1, wherein each of the plurality of ribs intermittently extends in the longitudinal direction, and
intermittent sections of each of the plurality of ribs constitute the connection flow paths.

4. The diaphragm of claim 3, wherein each of the plurality of ribs includes a plurality of sub-ribs which protrude from the inner surface of the diaphragm body to be in contact with the outer surface of the outer tube and are disposed in a line to be spaced apart from each other in the longitudinal direction,
each of the plurality of sub-ribs is formed to have a predetermined length in the longitudinal direction and a predetermined width in the circumferential direction, and
separation spaces between the plurality of sub-ribs constitute the connection flow paths.

5. The diaphragm of claim 4, wherein the plurality of ribs include first ribs and second ribs alternately disposed in the circumferential direction,
each of the first ribs includes a plurality of first sub-ribs which protrude from the inner surface of the diaphragm body to be in contact with the outer surface of the outer tube and are disposed in a line to be spaced apart from each other in the longitudinal direction,
each of the second ribs includes a plurality of second sub-ribs which protrude from the inner surface of the diaphragm body to be in contact with the outer surface of the outer tube and are disposed in a line to be spaced apart from each other in the longitudinal direction, and the plurality of first sub-ribs and the plurality of second sub-ribs are obliquely disposed to be spaced apart from each other in the circumferential direction.

6. The diaphragm of claim 5, wherein the plurality of second sub-ribs are disposed such that a center of each of the second sub-ribs in the longitudinal direction and a center of a first separation space located in the longitudinal direction and corresponding to each of the second sub-ribs among first separation spaces between the plurality of first sub-ribs are arranged in a line in the circumferential direction, and
the plurality of first sub-ribs are disposed such that a center of each of the first sub-ribs in the longitudinal direction and a center of a second separation space located in the longitudinal direction and corresponding to each of the first sub-ribs among second separation spaces between the plurality of second sub-ribs are arranged in a line in the circumferential direction.

7. The diaphragm of claim 6, wherein a length of each of the first sub-ribs is 1.0 times to 5.0 times a length of the second separation space corresponding to each of the first sub-ribs, and
a length of each of the second sub-ribs is 1.0 times to 5.0 times a length of the first separation space corresponding to each of the second sub-ribs.

8. The diaphragm of claim 5, wherein the plurality of first sub-ribs have an equal length and are spaced apart from each other at equal intervals, and
the plurality of second sub-ribs have an equal length and are spaced apart from each other at equal intervals.

9. The diaphragm of claim 8, wherein a length of the first separation space between the plurality of first sub-ribs is 0.2 times to 1.0 times a length of any one of the plurality of first sub-ribs, and
a length of the second separation space between the plurality of second sub-ribs is 0.2 times to 1.0 times a length of any one of the plurality of second sub-ribs.

10. The diaphragm of claim 9, wherein a length of the plurality of first sub-ribs is equal to a length of the plurality of second sub-ribs, and
the length of the first separation space between the plurality of first sub-ribs is equal to the length of the second separation space between the plurality of second sub-ribs.

11. The diaphragm of claim 5, wherein the plurality of first sub-ribs and the plurality of second sub-ribs have an equal width, and
a separation distance between the plurality of first sub-ribs and the plurality of second sub-ribs in the circumferential direction is 0.5 times to 3.0 times a width of any one of the plurality of first sub-ribs and the plurality of second sub-ribs.

12. The diaphragm of claim 4, wherein at least one sub-rib of the plurality of sub-ribs is formed such that a central area thereof in the longitudinal direction has a predetermined width.

13. The diaphragm of claim 12, wherein the at least one sub-rib is formed such that a cross section thereof in a protruding direction has a quadrangular shape having round corners.

14. The diaphragm of claim 12, wherein the at least one sub-rib is formed such that a cross section thereof in a protruding direction has a capsule shape.

15. The diaphragm of claim 4, wherein at least one sub-rib of the plurality of sub-ribs is formed such that a width thereof increases and then decreases in the longitudinal direction.

16. The method of claim 15, wherein the at least one sub-rib is formed such that a cross section thereof in a protruding direction has a rhombus shape having round corners.

17. The diaphragm of claim 15, wherein the at least one sub-rib is formed to have a hexagonal shape which has a symmetrical structure in a width direction, of which a pair of sides facing each other are located at both end portions in the longitudinal direction, and of which corners are round.

18. The diaphragm of claim 1, wherein each of the plurality of ribs includes a single body continuously extending in the longitudinal direction, and
a through-hole passing though the single body in the circumferential direction is formed and constitutes the connection flow path.

19. The diaphragm of claim 18, wherein the through-hole formed in the single body is provided as a plurality of through-holes, and
the plurality of through-holes are formed to be spaced apart from each other in the longitudinal direction.

20. The diaphragm of claim 19, wherein the plurality of ribs include first ribs and second ribs alternately disposed in the circumferential direction,
each of the first ribs includes a first single body continuously extending in the longitudinal direction,
a plurality of first through-holes passing through the first single body in the circumferential direction are formed to be spaced apart from each other in the longitudinal direction,
each of the second ribs includes a second single body continuously extending in the longitudinal direction,
a plurality of second through-holes passing through the second single body in the circumferential direction are formed to be spaced apart from each other in the longitudinal direction, and
the plurality of first through-holes and the plurality of second through-holes are obliquely disposed to be spaced apart from each other in the circumferential direction.
